(19) United States
(12) Patent Application Publication
(10) Pub. No.: US 2026/0162282 A1
(43) Pub. Date: Jun. 11, 2026

(54) METHOD AND APPARATUS FOR TRAINING A STUDENT NETWORK OF A TEACHER-STUDENT TRAINING ARCHITECTURE

(71) Applicant: Robert Bosch GmbH, Stuttgart (DE)

(72) Inventors: Alexandru Paul Condurache, Renningen (DE); Andre Wagner, Hannover (DE); Christian Loewens, Hannover (DE); Thorben Funke, Sarstedt (DE)

(21) Appl. No.: 19/307,809

(22) Filed: Aug. 22, 2025

(30) Foreign Application Priority Data
Aug. 26, 2024 (DE) 10 2024 208 100.0

(51) Int. Cl. G06T 7/33

(52) U.S. Cl. CPC G06T 7/337; G06T 2207/20081; G06T 2207/20084

(57) ABSTRACT

A method for training a student network of a teacher-student training architecture for point-cloud registration for mapping an environment for navigation of a technical system. The teacher-student training architecture includes a teacher network and the student network.

### FIELD

The present invention relates to a method for training a student network of a teacher-student training architecture for point-cloud registration for mapping an environment for navigation of a technical system. The present invention relates to an apparatus for training a student network of a teacher-student training architecture for point-cloud registration for mapping an environment for navigation of a technical system. The present invention relates to a method for point-cloud registration for mapping an environment for navigation of a technical system. The present invention relates to a computer program having program code. The present invention relates to a computer-readable data carrier having program code of a computer program.

### BACKGROUND INFORMATION

Map-matching or registration methods for mapping are used, for example, in the field of autonomous driving and robot navigation. Such map registration methods can be used to create maps of an environment. Autonomous vehicles and/or robots can then, for example, navigate on the basis of such maps.

The map-matching and registration methods serve to standardize sensor data used for mapping. For example, it is thus possible for sensors to observe an environment from different viewing angles and/or views, thereby generating different sensor data that nevertheless represent the same real environment. In order to standardize these different sensor data, map-matching or registration methods are used, by means of which the sensor data are standardized or transformed into a common reference system in order to make uniform mapping of the environment possible. The aim of such map-matching (also called scan-matching) is to determine an aligning transformation between different input data, which can come from any sensors and/or from different viewing angles. This transformation is usually a central first step in creating a consolidated map from multiple, partially overlapping sensor data (or a representation derived therefrom).

For example, a vehicle camera can capture a lane marking from different viewing angles during driving. Scan-matching allows the captured camera data to be matched, in particular by pixel-matching. A similar approach also applies to point-cloud data captured by lidar sensors and/or radar sensors, which can be related to a common reference system by map-matching or registration methods.

Extensive literature already exists in the research field of map-matching and registration methods, which describes not only classical analytical approaches but increasingly machine learning approaches as well (ML approaches for short). In the field of ML-based approaches, several methods have emerged in recent years for overcoming the necessity of a (manual) assignment of ground truth labels, which entails an enormous labeling effort and thus a considerable time expenditure.

The authors of H. Yang et al. “Self-supervised geometric perception” in Proceedings of the IEEE/CVF Conference on Computer Vision and Pattern Recognition, pp. 14350-14361, 2021, find inspiration in student-teacher architectures and specifically propose an SGP algorithm. Here, a student is a trainable feature matcher that outputs suspected correspondences between the input data to be matched or standardized. A RANSAC part of the teacher, on the other hand, is a non-learning, robust solver that only values rigid transformations between the input data to be matched or standardized. The predicted transformations are then used as pseudo-labels in order to monitor the student and thereby to iteratively improve the pseudo-labels. According to this approach, the student is trained with the same pseudo-labels over several epochs until the teacher generates new labels.

The authors of Q. Liu et al. “Extend your own correspondences: Unsupervised distant point cloud registration by progressive distance extension” (arXiv preprint arXiv: 2403.03532, 2024) extend the approach proposed in H. Yang et al. to automotive datasets by progressively increasing the distance between point clouds and spatially filtering correspondences in the immediate vicinity of an ego vehicle. Similarly to H. Yang et al., a non-learning robust solver is used as a teacher, but SC2-PCR is chosen.

The authors of M. El Banani and J. Johnson, “Bootstrap your own correspondences” in Proceedings of the IEEE/CVF International Conference on Computer Vision, pp. 6433-6442, 2021, exploit the fact that images and point clouds are coupled in RGB-D data and train a point-cloud feature extractor with pseudo-labels obtained from a randomly initialized image feature extractor.

Several conventional methods in the image field thus demonstrate an effective use of a model's own prediction in order to improve training without extensively labeled training data.

Even though some approaches are already described in the related art, there is still potential for improvement. It is therefore an object of the present invention to specify a further improved method and/or an improved apparatus.

The object may be achieved by a method having certain features of the present invention. The object may also be achieved by an apparatus having certain features of the present invention.

### SUMMARY

According to a first aspect of the present invention, a method is provided for training a student network of a teacher-student training architecture for point-cloud registration for mapping an environment for navigation of a technical system. The teacher-student training architecture has a teacher network (teacher for short) and the student network (student for short). According to an example embodiment of the present invention, the method comprises these steps:
providing a first point cloud for points of an object in the environment and a second point cloud for points of the object in the environment, wherein the points of the first and the second point cloud register the object from different fields of view;
extracting features from the points of the first and the second point cloud by an encoder in the teacher network;
extracting features from points of a respectively augmented first and second point cloud by an encoder in the student network;
estimating point pairs between the extracted point features of the first and the second point cloud, which are embedded in an embedding space by a decoder in the teacher network;
estimating point pairs between the extracted point features of the augmented first and the augmented second point cloud, which are embedded in an embedding space by a decoder in the student network;
optimizing the distances estimated by the decoder by applying an optimization algorithm to remove outliers from the estimated distances and by subsequently applying an iterative closest point algorithm to maximize a correspondence or a rigid transformation between the extracted point features of the first and the second point cloud;
generating new point pairs on the basis of the correspondence/rigid transformation between the extracted point features of the first and the second point cloud by applying a nearest neighbor algorithm;
optimizing a loss function on the basis of the point distances estimated by the decoder in the student network and the newly generated point distances in order to train the student network; and
providing the trained student network for point-cloud registration for mapping the environment for navigation of the technical system.

It is understood that the steps according to the present invention, as well as other optional steps, do not necessarily have to be executed in the order shown, but can also be executed in a different order. Other intermediate steps can also be provided. The individual steps can also comprise one or more sub-steps without departing from the scope of the method according to the present invention.

According to a second aspect of the present invention, an apparatus is provided for training a student network of a teacher-student training architecture for point-cloud registration for mapping an environment for navigation of a technical system. The teacher-student training architecture comprises a teacher network and the student network. According to an example embodiment of the present invention, the apparatus comprises an evaluation and computing unit which is designed to execute the following steps:
providing a first point cloud for points of an object in the environment and a second point cloud for points of the object in the environment, wherein the points of the first and the second point cloud register the object from different fields of view;
extracting features from the points of the first and the second point cloud by an encoder in the teacher network;
extracting features from points of a respectively augmented first and second point cloud by an encoder in the student network;
estimating point pairs of the first and the second point cloud by a decoder in the teacher network;
estimating point pairs between the extracted point features of the augmented first and the augmented second point cloud, which are embedded in an embedding space by a decoder in the student network;
optimizing the distances estimated by the decoder by applying an optimization algorithm to remove outliers from the estimated distances and by subsequently applying an iterative closest point algorithm to maximize a correspondence or a rigid transformation between the extracted points of the first and the second point cloud;
generating new point pairs on the basis of the correspondence/rigid transformation between the extracted point features of the first and second point cloud by applying a nearest neighbor algorithm;
optimizing a loss function on the basis of the point distances estimated by the decoder in the student network and the newly generated point distances in order to train the student network; and
providing the trained student network for point-cloud registration for mapping the environment for navigation of the technical system.

The explanations given for the method of the present invention apply accordingly to the apparatus of the present invention. It is understood that linguistic modifications of features formulated for the method of the present invention can be reformulated for the apparatus in accordance with standard linguistic practice, without such formulations having to be explicitly listed here.

Here, according to an example embodiment of the present invention, a self-distillation approach is proposed for learning the registration of point clouds in an unsupervised manner. Each sample of point cloud pairs is transmitted to a teacher network and an augmented sample of the point cloud pairs is transmitted to a student network. The teacher includes a (hyper-) parameter-trainable feature extractor or the encoder and a solver or decoder. The decoder, together with the encoder, is preferably part of a common neural network. For example, the teacher may also comprise a RANSAC part. The RANSAC part is preferably non-learning and robust. The solver preferably enforces a consistency of correspondence between point pairs and optimizes an unsupervised inlier ratio in order to eliminate the need for ground truth labels. This approach thus simplifies the training method compared to related methods and outperforms them for multiple datasets of point cloud pairs. The present approach simplifies unsupervised point-cloud registration by eliminating the need for a pseudo-label verifier. Furthermore, no manually labeled bootstrap features or progressive data sets are necessary.

The first and the second point cloud are voxelized and passed to the teacher's feature extractor. This predicts latent features for all points in the point clouds. The student receives an expanded or augmented version of the point clouds. For all points in the first point cloud, the corresponding points in the second point cloud are searched for, wherein the distance between the teacher's features should be minimal, which leads to the estimated correspondences or point pairs. The correspondence prediction is improved by applying RANSAC followed by the ICP algorithm. New refined correspondences are then generated by a nearest neighbor search in the coordinate space.

According to an example embodiment, the present method uses a so-called mean-teacher model based on a teacher-student architecture in which the teacher is an exponential average (EMA) of the student's parameters, thus promoting the consistency of predictions for semi-supervised learning.

Furthermore, this can thus eliminate the need to label training data.

According to an example embodiment, the present method preferably uses the technique of self-distillation by using an in particular non-contrastive loss function for the optimization of the pseudo-class labels. The present data augmentation used to train the student preferably improves a generalization. The data augmentation of further input data may preferably comprise rotation, noise generation and/or distortion of input data.

The present invention is located in the field of mapping or map-matching. The present invention is particularly applicable in the field of autonomous driving and/or robot navigation and/or generally in the navigation of a technical system in an environment. The present invention is used in connection with the creation of maps and thus in the field of robot navigation and mapping. The present invention contributes to the optimized creation of maps, which can be used in particular as sensors in technical systems for navigation in an environment.

The present invention can be used to analyze (input) data originating from a real or a virtual (simulated) sensor. Such a real or virtual sensor can, for example, capture or simulate measurements of an environment in the form of sensor signals or sensor data. The sensor data can be pixel-based, in particular digital, image and/or video data. Such image and/or video data can be captured, for example, by a camera, a thermal imaging camera, a motion sensor and/or a video camera. The sensor data can also be available as point-cloud data. Such point-cloud data can be captured, for example, by a radar sensor and/or a lidar sensor and/or an ultrasonic sensor.

The sensor data that can be actually captured or synthetically generated can preferably include data related to an ego vehicle and relevant for mapping, such as positions of lane markings, traffic signs, posts and/or other objects in vehicle-related coordinates. Furthermore, such sensor data may contain additional semantic information. The actual sensor origin or the reference system underlying the capturing is irrelevant.

On the basis of the sensor signal, information can preferably be obtained about elements or objects in the environment of a sensor, which information is encoded by the sensor signal. In other words, an indirect measurement can be performed on the basis of a sensor signal used as a direct measurement. The present invention can preferably be used to classify the sensor data, to detect the presence of objects in the sensor data and/or to perform a semantic segmentation of the sensor data, e.g., with respect to traffic signs. Furthermore, the present invention can be used to determine one or more continuous values, i.e. to perform a regression analysis, e.g. with respect to an aligning transformation of the given input data. The present invention can further be used to control a technical system, in particular to calculate a control signal for controlling a technical system, such as a computer-controlled machine, such as a robot system, a vehicle, a household appliance, a power tool, a manufacturing machine, a personal assistant and/or an access control system. Furthermore, the present invention can be used in an information transmission system, such as a monitoring system or a medical (imaging) system. The present invention makes it possible to create (standardized) maps that can be used by a technical system as a sensor replacement for navigation.

It should be noted that the present method can also be applied to pixel-based images instead of point clouds. The method steps could be as follows:
providing a first image with pixels of an object in the environment and a second image with pixels of the object in the environment, wherein the pixels of the first and the second image register the object from different fields of view;
extracting features from the pixels of the first and the second image by an encoder in the teacher network;
extracting features from pixels of a respectively augmented first and second image by an encoder in the student network;
estimating pixel distances between the extracted pixel features of the first and the second image by a decoder in the teacher network;
estimating pixel distances between the extracted pixel features of the augmented first and the augmented second image by a decoder in the student network;
optimizing the pixel distances estimated by the decoder by applying an optimization algorithm to remove outliers from the estimated pixel distances and by subsequently applying an iterative closest point algorithm to maximize a correspondence between the extracted pixel features of the first and the second image;
generating new pixel distances on the basis of the correspondence/transformation between the extracted pixel features of the first and the second image by applying a nearest neighbor algorithm;
optimizing a loss function on the basis of the pixel distances estimated by the decoder in the student network and the newly generated pixel distances in order to train the student network; and
providing the trained student network for image registration for mapping the environment for navigation of the technical system.

In a further aspect of the present invention, it is provided that the loss function comprises a contrastive loss function, wherein the loss function is optimized until a threshold is reached or until a prespecified number of training runs is reached.

In the present case, a contrastive loss is adapted for training the student network. Since no ground truth labels are available, the positive (inlier) point pairs of the point distances estimated by the teacher network or the predicted correspondences are used. Below a certain threshold the negative (outlier) point pairs are ignored. Excluding a verifier has been shown to lead to better performance.

In another aspect of the present invention, it is provided that the student network and the teacher network have the same network architecture.

A student-teacher architecture is used, in which the teacher generates pseudo-labels during ongoing operation in order to train the student. This approach makes a continuous improvement of the pseudo-labels possible. This means that new pseudo-labels do not have to be generated after a complete training run over several epochs. The teacher network is updated with the aid of an EMA of the student's parameters and for this reason uses the same architecture. A robust solver is integrated into the teacher to improve its estimating. In the final step, a form of contrast loss is applied in which the positive point pairs are determined by the teacher's estimated correspondences to point pairs or resulting distances.

In a further aspect of the present invention, it is provided that the encoder in the teacher network is a parameter-trainable encoder, the parameters of which are trained or updated by an exponential moving average of parameters of the encoder in the student network. In a further aspect, it is proposed that the decoder in the teacher network is a parameter-trainable decoder, the parameters of which are trained or updated by an exponential moving average of parameters of the decoder in the student network.

The phrase “teacher network is updated with the aid of an EMA of the student's parameters” describes a method for updating the parameters of the teacher network in a teacher-student architecture. This method uses the exponential moving average (EMA) of the student network parameters to update the teacher network parameters. In this architecture, the teacher network serves as a reference model, while the student network is a model trained to imitate the behavior of the teacher network. During the training process, the parameters of the student network are continuously adjusted to optimize performance. Updating the teacher network with the aid of an EMA is effected as follows: instead of directly and immediately inheriting the teacher network parameters from the current student network parameters, a smoothed version of these parameters is calculated.

The exponential moving average (EMA) weights younger values more heavily than older ones, which smooths and stabilizes sudden changes and fluctuations in the student parameters. Specifically, this means that the teacher network parameters represent a continuously adjusted, smoothed version of the student parameters. This method provides more stable parameters in the teacher network by toning down rapid and potentially excessive changes in student parameters. This makes the teacher network more robust and less susceptible to noise and short-term fluctuations.

In a further aspect of the present invention, it is provided that the augmented first point cloud is generated by data augmentation from the first point cloud and the augmented second point cloud is generated by data augmentation from the second point cloud, wherein the data augmentation comprises rotating and/or distorting and/or shifting data points of the first and/or the second point cloud.

For example, in the forward run, both point clouds are randomly rotated to generate the augmented point clouds and to force the student network to become rotation-invariant. In the distillation process, it is important to overcome the bootstrap phase, in which the randomly initialized teacher may provide less useful pseudo-labels. Here, the teacher has not yet been trained to be rotation-invariant and therefore performs less well with extended samples. To get round this, the augmentation is applied only to the student's input.

In another aspect of the present invention, it is provided that the optimization algorithm for removing outliers comprises a RANSAC (random sample consensus) algorithm, finds a set of inliers in the estimated point pairs, and ignores outliers in the estimated point pairs.

RANSAC (random sample consensus) is an iterative algorithm for estimating a set of parameters in a model from a dataset that may contain outliers. The main aim of RANSAC is to find a set of inliers (data points that belong to a particular model) from the given data and ignore outliers (data points that do not fit the model).

The ICP (iterative closest point) algorithm is a widely used algorithm for point-cloud registration. It is used to transform two point clouds in such a way as to maximize their correspondence or a rigid transformation. The ICP algorithm is widely used in computer vision, robotics, and 3D modeling.

In a further aspect of the present invention, a method is provided for point-cloud registration for mapping an environment for navigation of a technical system. According to an example embodiment of the present invention, the method comprises the following steps:
capturing a first point cloud of points of an object in the environment, in particular starting from the technical system from a first field of view;
capturing a second point cloud of points of the object in the environment, in particular starting from the technical system from a second field of view which differs from the first field of view;
registering the first point cloud and the second point cloud by the currently trained student network for mapping the environment; and
navigating the technical system in the mapped environment on the basis of the registered first and second point cloud.

In a further aspect of the present invention, a computer program having program code is provided for executing at least parts of the present method in one of its aspects when the computer program is executed on a computer. In other words, a computer program (product) comprising instructions which, when the program is executed by a computer, cause the computer to carry out the method/the steps of the method in one of its aspects.

In a further aspect of the present invention, a computer-readable data carrier having program code of a computer program is proposed for executing at least parts of the present method in one of its aspects when the computer program is executed on a computer. In other words, the present invention relates to a computer-readable (memory) medium comprising instructions which, when executed by a computer, cause the computer to carry out the method/the steps of the method in one of its aspects.

The described embodiments and developments of the present invention can be combined with one another as desired.

Further possible embodiments, developments and implementations of the present invention also include combinations not explicitly mentioned of features of the present invention described above or in the following relating to the exemplary embodiments.

### BRIEF DESCRIPTION OF THE DRAWINGS

The figures are intended to impart further understanding of the embodiments of the present invention. They illustrate example embodiments and, in connection with the description, serve to explain principles and concepts of the present invention.

Other embodiments and many of the mentioned advantages are apparent from the figures. The illustrated elements of the figures are not necessarily shown to scale relative to one another.

FIG. 1 shows a flowchart of an exemplary embodiment of the present invention.

FIG. 2 shows a block diagram of an exemplary embodiment of the present invention.

### DETAILED DESCRIPTION OF EXAMPLE EMBODIMENTS

In the figures, identical reference signs denote identical or functionally identical elements, parts or components, unless stated otherwise.

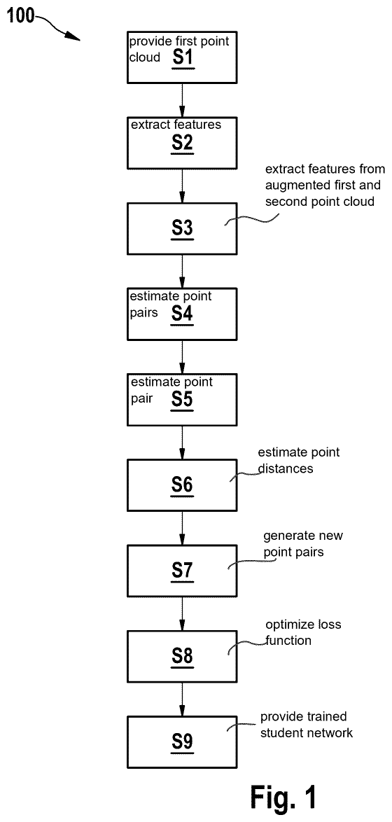

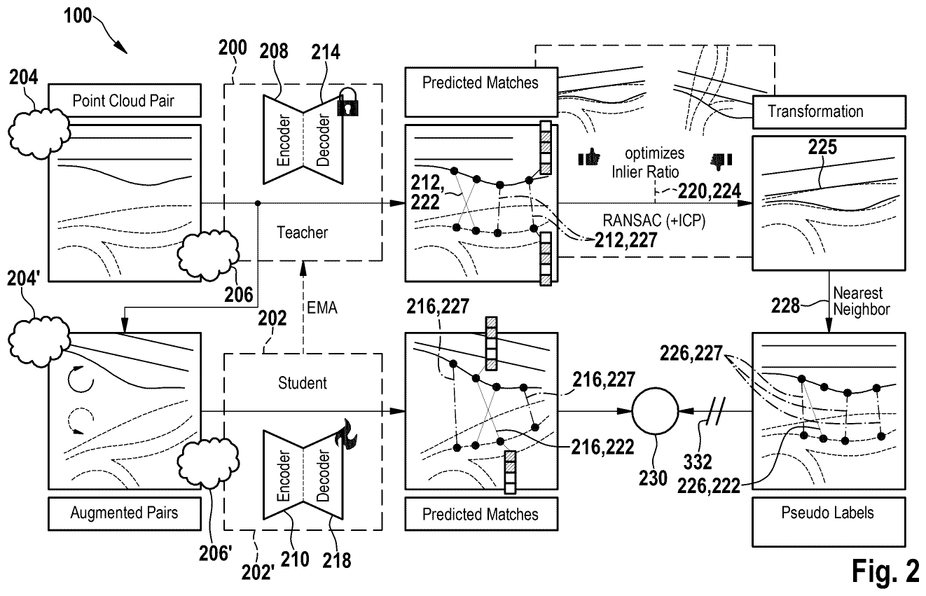

FIG. 1 shows a schematic flowchart of a method for training a student network of a teacher-student training architecture for point-cloud registration for mapping an environment for navigation of a technical system. The method is also described with the aid of FIG. 2.

The teacher-student training architecture comprises a teacher network 200 and the student network 202.

In any embodiment, the method can be carried out, at least in part, by an apparatus 100, which, for this purpose, can comprise a plurality of components not shown in more detail, for example one or more provisioning units and/or at least one evaluation and computing unit. It is self-evident that the provisioning unit can be designed together with the evaluation and computing unit or can be different therefrom. Furthermore, the apparatus 100, which can be part of a system, can comprise a storage unit and/or an output unit and/or a display unit and/or an input unit.

The computer-implemented method comprises at least the following steps:
In a step S1, a first point cloud 204 is provided for points of an object in the environment and a second point cloud 206 is provided for points of the object in the environment, wherein the points of the first and the second point cloud 204, 206 register the object from different fields of view.

In a step S2, features are extracted from the points of the first and the second point cloud 204, 206 by an encoder 208 in the teacher network 200. The encoder 208 in the teacher network 200 is a parameter-trainable encoder, the parameters of which are trained or updated by an exponential moving average of parameters of an encoder 210 in the student network 202.

In an optional step, the first and second point cloud 204, 206 or the respective points are augmented by data augmentation so that a first augmented point cloud 204′ and a second augmented point cloud 206′ are generated. The data augmentation may include rotating and/or distorting and/or shifting data points of the first and/or the second point cloud 204, 206.

In a step S3, features are extracted from points of the respectively augmented first and second point cloud 204′, 206′ by the encoder 210 in the student network 202.

In a step S4, point pairs 212 are estimated between the extracted point features of the first and the second point cloud 204, 206, which are embedded in an embedding space by a decoder 214 in the teacher network 200. The decoder 214 embeds the point features in a metric space. In this space, the point distances 212 are calculated with the aid of a Euclidean distance.

In a step S5, point pairs 216 are estimated between the extracted point features of the augmented first and the augmented second point cloud 204′, 206′, which are embedded in an embedding space by a decoder 218 in the student network 202.

In a step S6, the point distances 212 estimated by the decoder 214 are optimized by applying an optimization algorithm 220 to remove outliers 222 from the estimated point pairs and by subsequently applying an iterative closest point algorithm 224 to maximize a correspondence 225 by means of a rigid transformation between the points of the first and the second point cloud 204, 206. The optimization algorithm 220 for removing outliers 222 comprises a RANSAC (random sample consensus) algorithm that finds a set of inliers 227 in the estimated point pairs 212 and ignores outliers 222 in the estimated point pairs 212.

In a step S7, by application of a nearest neighbor algorithm 228, new point pairs 226 are generated on the basis of the correspondence 225 or a rigid transformation between the points of the first and the second point cloud 204, 206.

In a step S8, a loss function 230 is optimized on the basis of the point distances 216 estimated by the decoder 218 in the student network 202 and the newly generated point distances 226 in order to train the student network 202. The loss function 230 has a contrastive loss function, wherein the loss function 230 is optimized until a threshold is reached or until a prespecified number of training runs is reached.

In a step S9, the trained student network 202′ is provided for point-cloud registration in order to map the environment for navigation of the technical system.

FIG. 2 shows self-distillation for registration (DiReg). Both point clouds 204, 206 are transferred to the teacher network 200, while the student network 202 receives the extended or augmented point clouds 204′, 206′. The networks 200, 202 preferably predict geometric features for all points in their point cloud pairs, 204, 206, 204′, 206′. Here, correspondences are preferably collected by searching for the nearest neighbors among the feature vectors of the teacher network 200. With the aid of these correspondences, RANSAC preferably estimates a rigid transformation or correspondence 225 to align both point clouds 204, 206. Next, the nearest neighbors in the coordinate space are searched for to obtain improved correspondences for monitoring the student network 202. Preferably, a stop gradient operator 232 is also used to illustrate that no backpropagation through the teacher network 200 occurs.

1-10. (canceled)

11. A method for training a student network of a teacher-student training architecture for point-cloud registration for mapping an environment for navigation of a technical system, wherein the teacher-student training architecture includes a teacher network and the student network, the method comprising the following steps:
providing a first point cloud for points of an object in the environment and a second point cloud for points of the object in the environment, wherein the points of the first and the second point cloud register the object from different fields of view;
extracting features from the points of the first point cloud and the second point clouds by an encoder in the teacher network;
extracting features from points of respectively augmented first and second point clouds by an encoder in the student network;
estimating point pairs between the extracted point features of the first and the second point clouds, which are embedded in a feature space by a decoder in the teacher network;
estimating point pairs between the extracted point features of the augmented first and the augmented second point cloud, which are embedded in a feature space by a decoder in the student network;
optimizing point distances estimated by the decoder by applying an optimization algorithm to remove outliers from the estimated point pairs and by subsequently applying an iterative closest point algorithm to maximize a correspondence between the points of the first and the second point cloud;
generating new point pairs based on the correspondence between the points of the first and the second point cloud by applying a nearest neighbor algorithm;
optimizing a loss function based on the point distances estimated by the decoder in the student network and newly generated point distances in order to train the student network; and
providing the trained student network for point-cloud registration for mapping the environment for navigation of the technical system.

12. The method according to claim 11, wherein the loss function includes a contrastive loss function, wherein the loss function is optimized until a threshold is reached or until a prespecified number of training runs is reached.

13. The method according to claim 11, wherein the student network and the teacher network have the same network architecture.

14. The method according to claim 11, wherein the encoder in the teacher network is a parameter-trainable encoder, parameters of the parameter-trainable encoder being trained or updated by an exponential moving average of parameters of the encoder in the student network, and wherein the decoder in the teacher network is a parameter-trainable decoder, parameters of the parameter-trainable decoder being trained or updated by an exponential moving average of parameters of the decoder in the student network.

15. The method according to claim 11, wherein the augmented first point cloud is generated by data augmentation from the first point cloud and the augmented second point cloud is generated by data augmentation from the second point cloud, wherein the data augmentation includes rotating and/or distorting and/or shifting data points of the first and/or the second point cloud.

16. The method according to claim 11, wherein the optimization algorithm for removing outliers includes a random sample consensus (RANSAC) algorithm and is configured to find a set of inliers in the estimated point pairs and to ignore outliers in the estimated point pairs.

17. A method for point-cloud registration for mapping an environment for navigation of a technical system, the method comprising the following steps:
capturing a first point cloud of points of an object in the environment, starting from the technical system from a first field of view;
capturing a second point cloud of points of the object in the environment, starting from the technical system from a second field of view which differs from the first field of view;
registering the first point cloud and the second point cloud by the student network trained for mapping the environment, the training of the student network including:
providing a third point cloud for points of an object in the environment and a fourth point cloud for points of the object in the environment, wherein the points of the thirdt and the fourth point cloud register the object from different fields of view,
extracting features from the points of the third point cloud and the fourth point clouds by an encoder in a teacher network,
extracting features from points of respectively augmented third and fourth point clouds by an encoder in the student network,
estimating point pairs between the extracted point features of the third and the fourth point clouds, which are embedded in a feature space by a decoder in the teacher network,
estimating point pairs between the extracted point features of the augmented thirdt and the augmented fourth point cloud, which are embedded in a feature space by a decoder in the student network,
optimizing point distances estimated by the decoder by applying an optimization algorithm to remove outliers from the estimated point pairs and by subsequently applying an iterative closest point algorithm to maximize a correspondence between the points of the first and the second point cloud,
generating new point pairs based on the correspondence between the points of the third and the fourth point cloud by applying a nearest neighbor algorithm,
optimizing a loss function based on the point distances estimated by the decoder in the student network and newly generated point distances in order to train the student network, and
providing the trained student network for the point-cloud registration for mapping the environment for navigation of the technical system; and
navigating the technical system in the mapped environment based on the registered first and second point cloud.

18. A non-transitory computer-readable data carrier on which is stored program code of a computer program for training a student network of a teacher-student training architecture for point-cloud registration for mapping an environment for navigation of a technical system, wherein the teacher-student training architecture includes a teacher network and the student network, the program code, when executed by a computer, causing the computer to perform the following steps:
providing a first point cloud for points of an object in the environment and a second point cloud for points of the object in the environment, wherein the points of the first and the second point cloud register the object from different fields of view;
extracting features from the points of the first point cloud and the second point clouds by an encoder in the teacher network;
extracting features from points of respectively augmented first and second point clouds by an encoder in the student network;
estimating point pair distances between the extracted point features of the first and the second point clouds, which are embedded in a feature space by a decoder in the teacher network;
estimating point pair distances between the extracted point features of the augmented first and the augmented second point cloud, which are embedded in a feature space by a decoder in the student network;
optimizing the point distances estimated by the decoder by applying an optimization algorithm to remove outliers from the estimated point pair distances and by subsequently applying an iterative closest point algorithm to maximize a correspondence between the points of the first and the second point cloud;
generating new point pair distances based on the correspondence between the points of the first and the second point cloud by applying a nearest neighbor algorithm;
optimizing a loss function based on the point pair distances estimated by the decoder in the student network and newly generated point pair distances in order to train the student network; and
providing the trained student network for point-cloud registration for mapping the environment for navigation of the technical system.

19. An apparatus for training a student network of a teacher-student training architecture for point-cloud registration for mapping an environment for navigation of a technical system, wherein the teacher-student training architecture includes a teacher network and the student network, the apparatus comprising:
an evaluation and computing unit configured to perform the following steps:
providing a first point cloud for points of an object in the environment and a second point cloud for points of the object in the environment, wherein the points of the first and the second point cloud register the object from different fields of view,
extracting features from the points of the first and the second point cloud by an encoder in the teacher network,
extracting features from points of respectively augmented first and second point clouds by an encoder in the student network,
estimating point pairs between the extracted point features of the first and the second point cloud, which are embedded in an embedding space by a decoder in the teacher network,
estimating point pairs between the extracted point features of the augmented first and the augmented second point cloud, which are embedded in an embedding space by a decoder in the student network,
optimizing point distances estimated by the decoder by applying an optimization algorithm to remove outliers from the estimated point pairs and by subsequently applying an iterative closest point algorithm to maximize a correspondence between the points of the first and the second point cloud,
generating new point pairs based the correspondence between the extracted point features of the first and the second point cloud by applying a nearest neighbor algorithm.
optimizing a loss function based on the point distances estimated by the decoder in the student network and newly generated point distances in order to train the student network; and
providing the trained student network for point-cloud registration for mapping the environment for navigation of the technical system.
